(19) United States
(12) Patent Application Publication
(10) Pub. No.: US 2015/0245200 A1
(43) Pub. Date: Aug. 27, 2015

(54) Processes for Protecting Privacy Through Mobile Device Signature-Hopping

(71) Applicants: Donald Henry, Menlo Park, CA (US); Charles Marshall, Atherton, CA (US)

(72) Inventors: Donald Henry, Menlo Park, CA (US); Charles Marshall, Atherton, CA (US)

(73) Assignee: DoNotGeoTrack, Inc., Atherton, CA (US)

(21) Appl. No.: 14/628,217

(22) Filed: Feb. 21, 2015

Related U.S. Application Data
(60) Provisional application No. 61/942,678, filed on Feb. 21, 2014.

(51) Int. Cl. H04W 12/02

(52) U.S. Cl. CPC H04W 12/02

(57) ABSTRACT

This disclosure allows greater privacy for mobile device users while maintaining functionality through a process of signature-hopping. Mobile devices have persistent identifiers or signatures which are used in providing device functionality (routing calls to the correct number, returning web queries to the originating device, and connection continuity in local area networks such as WiFi®. These persistent identifiers or signatures can also be collected by unintended recipients or used by intended recipients to correlate, track, or otherwise discover information about the user of the device in extremely intrusive ways. Regularly changing these signatures can mitigate privacy problems for mobile device users, and the disclosure here shows how functionality may be maintained through these changes.

### CROSS REFERENCE TO RELATED APPLICATIONS

The present application relates to and claims priority of U.S. provisional patent application (“Copending Provisional Application”), Ser. No. 61/948,678, entitled “PROCESSES TO ENABLE INDIVIDUALS TO OPT OUT (OR BE OPTED OUT) OF VARIOUS FACIAL RECOGNITION AND OTHER SCHEMES AND ENABLE BUSINESSES AND OTHER ENTITIES TO COMPLY WITH SUCH DECISIONS AND A PROCESS FOR PROTECTING PRIVACY THROUGH MOBILE DEVICE SIGNATURE-HOPPING,” filed on Feb. 21, 2014. The disclosure of the Copending Provisional Application is hereby incorporated by reference in its entirety.

### BACKGROUND OF THE INVENTION

1. Field of Invention

The present application disclosures a signature-hopping process to allow mobile device users greater privacy while maintaining device functionality. The process periodically updates discernable signatures of the mobile device to complicate and deter intrusive and unauthorized data collection and correlation. A cellular services carrier or other entity keeps track of the changing signatures to ensure continuity of communications and data flow to and from the device.

2. Discussion of Related Art

In an interconnected age, mobile device users have few means of using an essential device while simultaneously protecting their privacy. Geo-tracking, license plate scanning, biometric readings, rampant data harvesting, cross-device and cross-site correlation, behavioral advertising, and financial services and employment screening of personal data are other areas of concern. Not all these privacy-invading practices depend on mobile device tracking and correlation, but the addition of mobile device tracking information often facilitates such intrusive technologies. Few means now exist to technologically rein in or allow mobile device users (or others) to opt-out of or frustrate these practices.

This disclosure allows greater privacy for mobile device users while maintaining functionality through a process of signature-hopping. Mobile devices have persistent identifiers or signatures which are used in providing device functionality (routing calls to the correct number, returning web queries to the originating device, and connection continuity in local area networks such as WiFi®). These persistent identifiers or signatures can also be collected by unintended recipients or used by intended recipients to correlate, track, or otherwise discover information about the user of the device in extremely intrusive ways. Regularly changing these signatures can mitigate privacy problems for mobile device users, and the disclosure here shows how functionality may be maintained through these changes.

### SUMMARY OF THE INVENTION

This application discloses a number of interrelated processes whereby individuals using mobile devices may enhance their privacy. The disclosed process applies a signature-hopping scheme to frustrate unconsented or unwanted collection activities while retaining the functionality of a device. To allow for selective collection under a technology, a further process is described which allows specific entities to continue to collect data from individuals. This might be with the knowledge and consent of the individual. Alternatively, it might be based on legal authority (such as a warrant).

The processes start with the individual registering his or her device with an opt-out registry (where the individual is opting out of unwanted collection based on the device signatures). The opt-out registry could be either maintained by the mobile services carrier (when there is one) or by a third party. Enrollment might be the default for some devices or mobile services carriers. Once enrolled, the individualized signatures (for example, the Media Access Control (MAC) address, the Mobile Identification Number (MIN), and the Bluetooth® address, the IP address) of his or her device will be changed frequently. This signature-hopping method will frustrate various sorts of collection and correlation activity while maintaining the functionality of the devices. The carrier maintains a record of the current and immediate past signatures for the device and ensures continuity of communications. Additional parties (consented or legally entitled) could work through the opt-out registry (or in the case of law enforcement, alternatively through the carrier directly when the entities are distinct) to verify that they are authorized to receive the data correlating a particular device to the shifting signatures over time.

### BRIEF DESCRIPTION OF THE DRAWINGS

FIG. 1 shows an illustrative example whereby a mobile device user registers to protect his or her privacy through the frequent changes of the devices signatures (signature-hopping).

FIG. 2 shows an illustrative example of how device functionality may be maintained with signature-hopping which may frustrate intrusive or unconsented data.

FIG. 3 shows a push architecture whereby signature-hopping device signals might be collected, tracked, and correlated by certain privileged entities.

FIG. 4 shows a pull architecture whereby certain privileged entities might query a registry to track and correlate signals from signature-hopping devices for which they entitled to receive data.

### DETAILED DESCRIPTION OF THE PREFERRED EMBODIMENTS

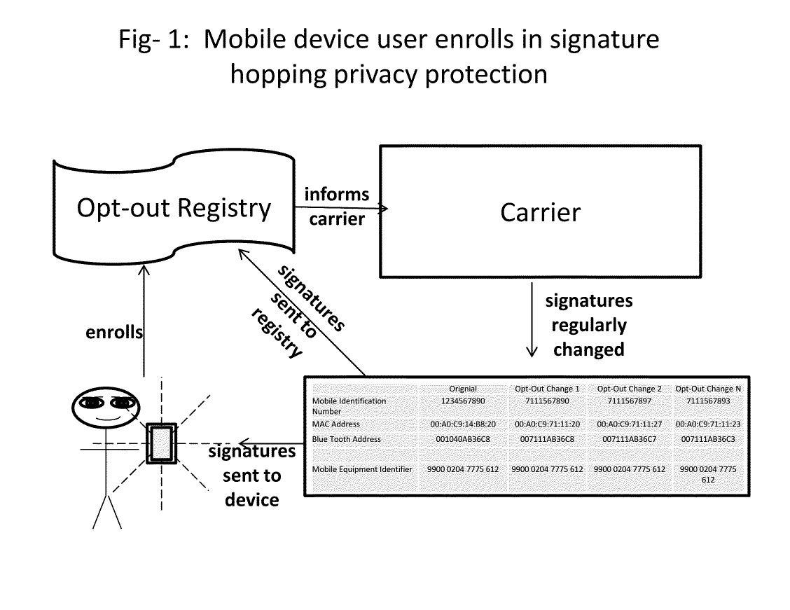

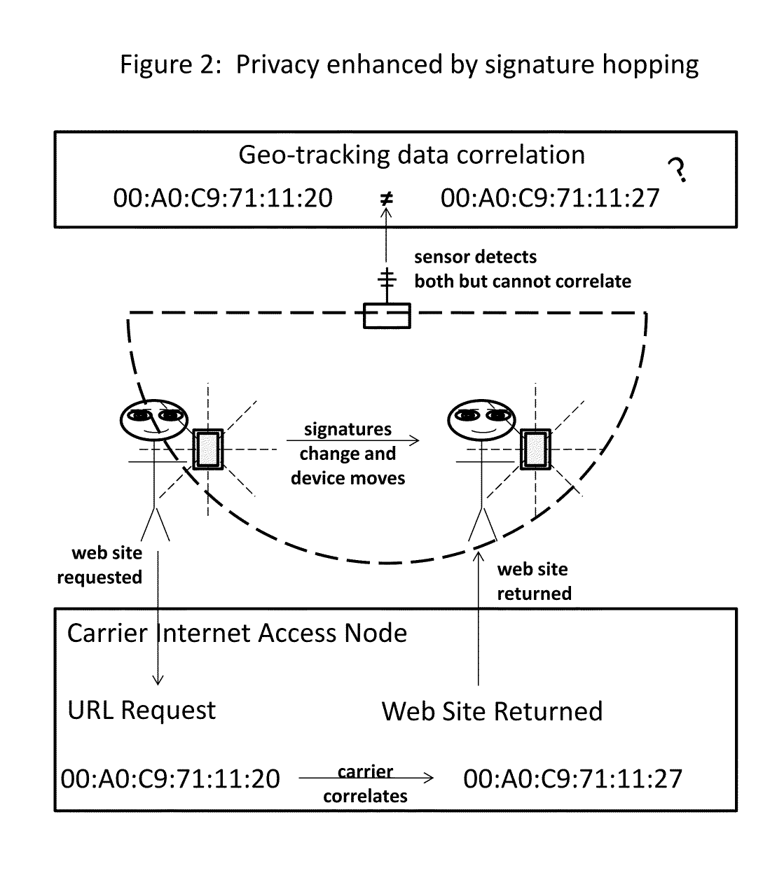

The processes start when a mobile device user enrolls in an opt-out or privacy registry requesting that the mobile service carrier change the detectable signatures of a mobile device with sufficient frequency to frustrate data collection and correlation efforts. For certain devices or mobile services carriers, enrollment might be the default. The opt-out privacy registry may be independent of or maintained by the mobile services carrier. Normally, detectable signatures of a mobile device are often fixed or remain static for long periods of time. As a consequence, intrusive data collection practices can exploit this privacy vulnerability to track the same device (and user) over long periods of time and correlate this information with other data which reveals details about a person's life that person would consider private. This process would introduce signature-hopping for a device whereby the mobile services carrier determines (or has another party determine) new values for detectable, individualized signatures (such as the Mobile Identification Number, the Bluetooth® address, the MAC address) or changeable but normally persistent signatures (i.e., IP (internet protocol) address with sufficient frequency to make unwanted or unconsented data collection efforts more difficult or impossible. While the signatures could still be harvested by unconsented or unwanted data collectors, they would be difficult to exploit for lack of continuity. The functionality of the device can be maintained because the mobile services carrier knows the continuity trail and can route voice, data, or other information to and from the correct device. It is possible that only some mobile devices have changeable signatures or that only some signatures can be changed on some devices. New or somewhat altered devices may be needed to fully exploit this method. FIG. 1 shows signatures being changed by the mobile services carrier and FIG. 2 shows a data collection effort frustrated by the signature-hopping method while device functionality is maintained.

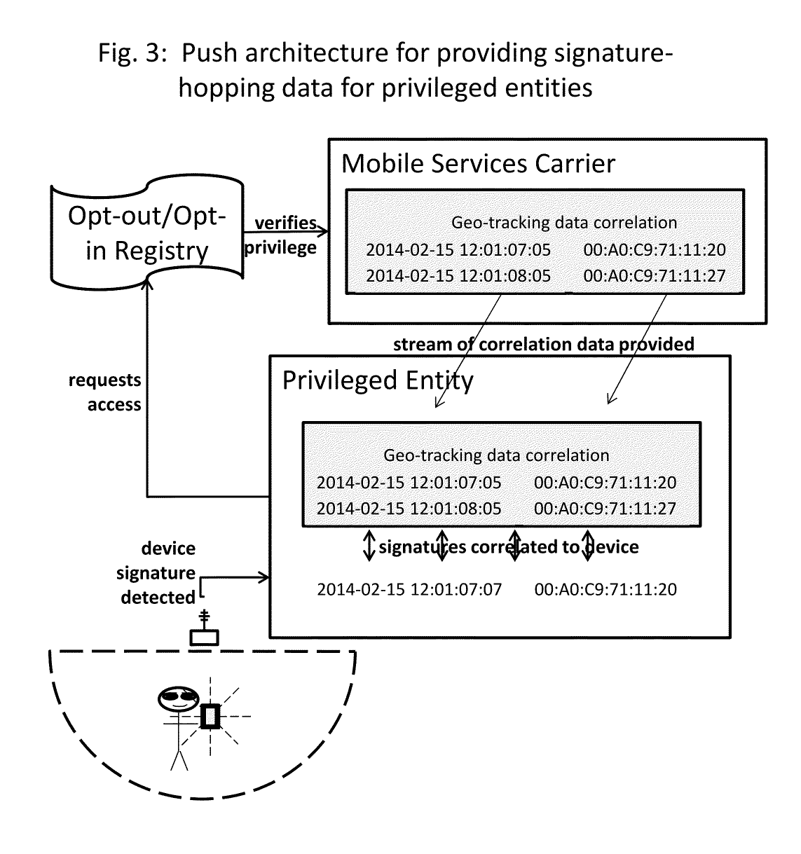

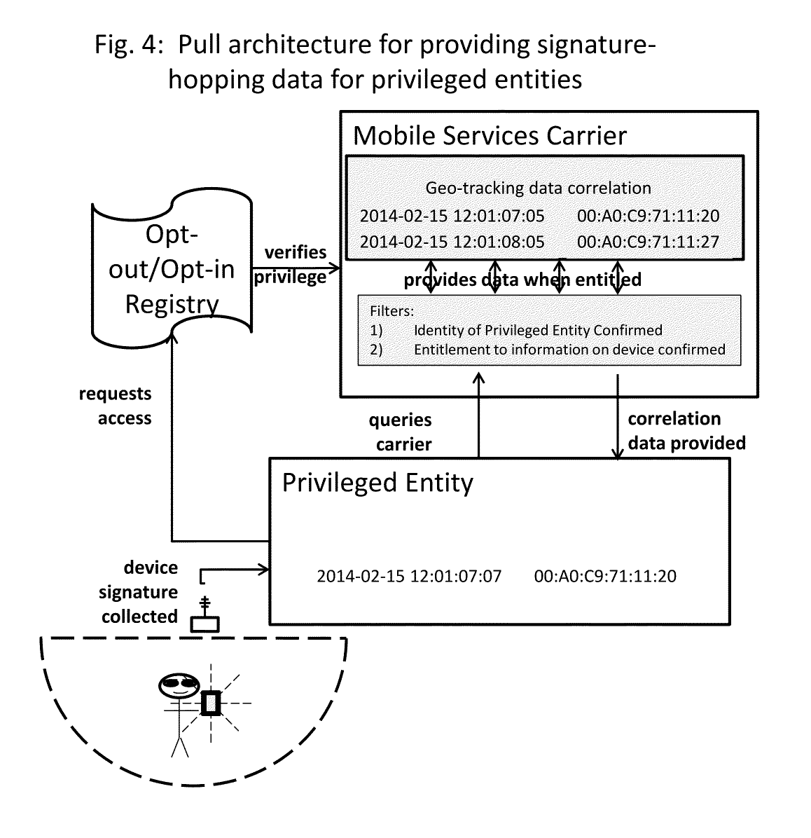

A variation or extension builds upon the previous process which allows a mobile services provider which has implemented a signature-hopping service for users can offer specific data collectors for which the mobile device user has consented to collection or other collectors where required or permitted by law (i.e., a warrant which allows geo-tracking of a suspected criminal) the ability to restore collect, correlate, and exploit signature-hopping information. A mobile device user would enroll to opt-in to certain data collection. For example, a mobile device user may have a favorite store it wishes to allow to collect data (with or without explicit or implicit compensation). A user may also work in a large industrial complex and want his location available to his employer while on the job. A parent may want to be able to track the location of his or her child through the child's mobile device. A police department may want to locate a fugitive based on the location of his or her mobile device. The user, the parent, or the police department would either deal with an opt-out/opt-in registry service independent of the carrier or such a service run by the carrier. The user or parent registers the device in an opt-out/opt-in registry and consents to specific businesses, people, or organizations being granted access to continuity data on the device. A law enforcement agency contacts the registry and establishes its authority to obtain the information. The specific businesses, people, organizations, or law enforcement agencies become privileged entities. Privileged entities can obtain continuity for data collection through two alternative methods. The carrier can provide near real time updates to each privileged for each of the devices for which the privileged user is entitled to obtain (a push architecture). See FIG. 3. Alternatively, the carrier can maintain a controlled access database whereby a privileged entity can submit a query on any device one of its sensors detects. The access controls for the database 1) verify identity of requesting entity, 2) internally correlates the device signature to a specific device, 3) determines whether or not the requesting entity is entitled to information on that specific device, and 4) provide identifiable information if and only if the requesting entity is entitled to such information (a pull architecture). See FIG. 4. Both alternatives could be used on near real time data or on stored or archived data.

What is claimed is:

1. A method whereby a central data clearinghouse or authority controls the dynamic assignment of mobile device signatures including but not limited to the Mobile Identification Number, MAC address, the Bluetooth® address, or any other detectable signature used now or in the future by a mobile device while deconflicting assignments of signatures to ensure their uniqueness and ensuring the correlation of these dynamically assigned numbers for devices to individuals or accounts for the purpose of functionality, billing, continuity of communications and data flow, and other purposes (i.e., tracking with a warrant). This clearinghouse or authority could be independent of or part of a mobile services carrier.

2. A specific embodiment of the above method 1 whereby dynamically assigned signatures for mobile devices are changed with sufficient frequency to impede or reduce the effectiveness of data collection and surveillance including but not limited to geo-tracking

3. A specific embodiments of method 1 whereby dynamically assigned signatures may be used to impede or reduce the effectiveness of data collection of browsing history and the serving of behavioral advertisements.

4. A refinement of method 1 whereby a mobile services carrier or other clearinghouse provides to certain privileged parties (for example those for whom the a user has opted-into or law enforcement agencies with a warrant) can be provided the signature history of a device so that the privileged party can correlate, track, and collect on the device notwithstanding the signature-hopping characteristic of the device.

5. A specific embodiment of the method 4 whereby a carrier, once it verifies the identity and privileged status of an entity, pushes near real time signature information to that entity.

6. Another specific embodiment of method 4 whereby a privileged entity queries a mobile services carrier about a signature it has detected and correlation data is provided if the identity of the entity can be verified and the privileged status of the entity with respect to the specific device whose signature has been collected can be confirmed.
